(19) United States
(12) Patent Application Publication
(10) Pub. No.: US 2015/0180264 A1
(43) Pub. Date: Jun. 25, 2015

(54) ANTENNA FOR WIRELESS CHARGING

(71) Applicant: Cambridge Silicon Radio Limited, Cambridge (GB)

(72) Inventor: Anthony McFarthing, Ely (GB)

(21) Appl. No.: 14/136,087

(22) Filed: Dec. 20, 2013

(51) Int. Cl. H02J 7/02; H02J 7/00

(52) U.S. Cl. CPC H02J 7/025; H02J 7/0042

(57) ABSTRACT

The present application relates to an antenna for wireless charging, the antenna comprising a coil having a fixed inductance and a fixed area, such that the antenna is operable in a frequency range of 100 kHz to 13.56 MHz.

### TECHNICAL FIELD

The present application relates to an antenna for use in wireless charging applications such as wirelessly rechargeable devices and wireless chargers, and to a wirelessly rechargeable device and a wireless charger incorporating the antenna.

### BACKGROUND TO THE INVENTION

There is increasing interest in the field of wireless charging for battery powered portable devices such as mobile telephones, tablet computers and the like. Devices capable of wireless charging need not be physically connected to a source of charging current such as a mains powered charger. Instead, such devices can simply be placed on a wireless charger, which wirelessly provides charging energy to the device, typically by inductive coupling.

There are a number of different wireless charging standards being promoted by different organisations. For example, the Wireless Power Consortium has developed a standard known as the Qi specification, whilst the Alliance for Wireless Power (A4WP) has developed its own standard. Additionally, proposals are being developed by the NFC Forum for using near field communications (NFC) technology for wireless charging.

At this time, the A4WP and NFC Forum standards are emerging, whereas many devices exist that use Qi for wireless charging. This situation may change in future as the A4WP standard is adopted by an increasing number of device manufacturers. The NFC Forum standard may ultimately prove to be the most cost effective for many applications however, as NFC systems and antennas are already present in a number of devices, and the use of NFC is set to increase. The cost involved in the addition of wireless charging circuitry to existing NFC equipped devices to permit wireless charging at NFC frequencies will be minimal due to the existing NFC infrastructure in the devices.

Until one of the existing and proposed wireless charging standards achieves a position of market dominance, device manufacturers face a difficult choice over which standard to adopt. One solution to this problem is to produce wireless charging hardware for either the charger or the device to be charged (or both) that can operate under all three standards.

However, the standards that exist or are proposed are incompatible with one another, as they operate in different frequency bands. The Qi standard uses a charging frequency of around 100 kHz, whilst the A4WP standard uses a charging frequency of around 6.78 MHz, and the standard proposed by the NFC Forum uses a charging frequency of around 13.56 MHz. This range of frequencies gives rise to a significant challenge, as although wideband amplifiers that support this range of frequencies are readily available, antennas that will work effectively across this frequency range are not.

### SUMMARY OF INVENTION

According to a first aspect of the invention there is provided an antenna for wireless charging, the antenna comprising a coil having a fixed inductance and a fixed area, such that the antenna is operable in a frequency range of 100 kHz to 13.56 MHz.

The fixed inductance may be around 8 μH, for example.

The fixed area may be in the range from around 1089 mm² to around 1899 mm².

For example, the fixed area may be around 1450 mm².

The coil may be generally spiral in shape.

Alternatively, the coil may be generally rectangular in shape.

According to a second aspect of the invention there is provided a wirelessly rechargeable device comprising an antenna according to the first aspect.

The wirelessly rechargeable device may further comprise a tuning component for tuning the antenna to a desired resonant frequency.

The tuning component may comprise a variable capacitance.

According to a third aspect of the invention there is provided a wireless charger comprising an antenna according to the first aspect.

The wireless charger may further comprise a tuning component for tuning the antenna to a desired resonant frequency.

The tuning component may comprise a variable capacitance.

### BRIEF DESCRIPTION OF THE DRAWINGS

Embodiments of the invention will now be described, strictly by way of example only, with reference to the accompanying drawings, of which

FIG. 1 is a schematic representation of a wireless charging system;

FIG. 2 is a schematic illustration showing exemplary alternative antenna shapes;

FIG. 3 is a graph illustrating received power at a target device using a universal antenna when a charging frequency of 13.56 MHz is used; and

FIG. 4 is a graph illustrating received power at a target device using a universal antenna when a charging frequency of between around 100 kHz and around 200 kHz is used.

### DESCRIPTION OF THE EMBODIMENTS

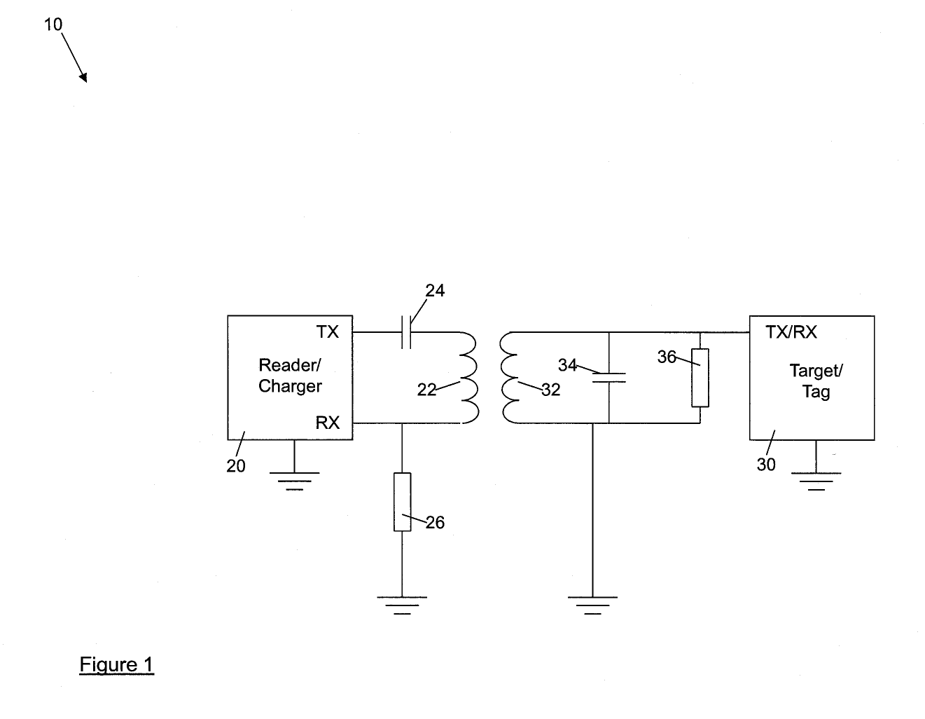

FIG. 1 is a schematic representation of a wireless charging system. The wireless charging system is shown generally at 10, and comprises a wireless charger 20 and a target device 30 containing a rechargeable battery to be charged. For the sake of clarity and brevity, only those components of the wireless charger 20 and the target device 30 that are relevant to the present invention are shown in FIG. 1, but it will be appreciated that the wireless charger 20 and the target device 30 will include additional components.

The wireless charger 20 includes a charging antenna 22 and a tuning capacitance 24, which together form a series resonant circuit. A power amplifier of the wireless charger 20 drives the charging antenna 22 and the tuning capacitance 24 with a carrier signal having a frequency defined by the wireless charging standard used. For example, if the wireless charger 20 complies with the Qi standard, the frequency of the carrier signal is of the order of 100-150 kHz, whilst if the wireless charger 20 is compliant with the A4WP standard the frequency of the carrier signal is around 6.78 MHz, and if the wireless charger 20 is compliant with the NFC Forum standard the frequency of the carrier signal is around 13.56 MHz. The tuning capacitance 24 is a capacitance of fixed value, which is selected to ensure that the charging antenna 22 is resonant at the carrier frequency used by the wireless charger 20, to facilitate optimum transmission of power to the target device 30.

The wireless charger 20 also includes a resistance 26, connected to the charging antenna 22, which is used for detecting a signal received from the target device 30 as load modulation. A charging control channel may operate on the same frequency as the charging carrier frequency. The may be achieved using communications techniques similar to those used in NFC, using amplitude modulation from the charger 20 to the target device 30 and load modulation from the target device 30 to the charger 20.

The target device 30 includes a universal antenna 32, that is to say an antenna that operates effectively at the frequencies used by the wireless charging standards currently available or contemplated without any reconfiguration of the antenna 32 itself. Thus, the universal antenna 32 used in the target device 30 is operable in a frequency range of around 100 kHz to around 13.56 MHz.

It will be appreciated by those skilled in the art that the universal antenna 32 is described here as being included in the target device 30 as the antenna 32 must be able to operate with existing Qi chargers which have charging antennas of specific sizes. However if there were no restrictions on size (as may occur as alternative wireless charging standards gain market traction), then a universal antenna 32 could be fitted to either the charger 20 or the target device 30. The basic concept of an antenna having a fixed self inductance that can span a wide frequency range whilst also achieving high power transfer efficiencies for wireless charging is applicable to any size or geometry of antenna.

The universal antenna 32 may be connected in parallel with a tuning capacitance 34 to form, with the tuning capacitance 34, a parallel resonant circuit. Alternatively, the target device 30 may use a series resonant circuit formed of the universal antenna and a series tuning capacitance 34. The choice of a parallel or series resonant circuit in the target device 30 will be dependent on the situation and application, as each approach has its advantages and disadvantages. The tuning capacitance 34 is variable, to tune the universal antenna 32 to the particular carrier frequency used by a wireless charger 20 from which the target device 30 is to receive charging power.

In the schematic illustration of FIG. 1, the universal antenna 32 is shown as being connected in parallel with an impedance 36. This represents either a load impedance of the target device 30 or a specific impedance connected to the universal antenna 32, or a combination of both. In any case, the impedance 36 is adjustable to permit the target device 30 to be charged by wireless chargers 20 operating according to different standards, as will be explained below.

The universal antenna 32 is designed to operate in the frequency range 100 kHz to 13.56 MHz, to permit charging of the target device using a wireless charger 20 operating on any one of the three available or contemplated wireless charging standards without requiring any reconfiguration of the antenna 32 itself, as discussed above. To this end, the universal antenna 32 comprises a coil of fixed self inductance and fixed area. The applicant has found that a coil having a fixed self inductance of around 8 μH and a fixed area of around 1450 mm² to be particularly suitable, but it is envisaged that other inductance value and area combinations would also provide acceptable results. In this context, the term “area” refers to the maximum area occupied by the antenna 32, i.e. the square of a longest dimension of the antenna 32.

The universal antenna 32 may be formed, for example, from one or more tracks of a conductive material such as copper printed, etched or otherwise provided on a substrate such as a printed circuit board. The tracks may be provided on one side of the substrate only, or may be provided on two opposed sides or faces of the substrate.

The universal antenna 32 may be configured to conform generally to the physical dimensions of a charging antenna used by existing wireless chargers operating under the Qi standard.

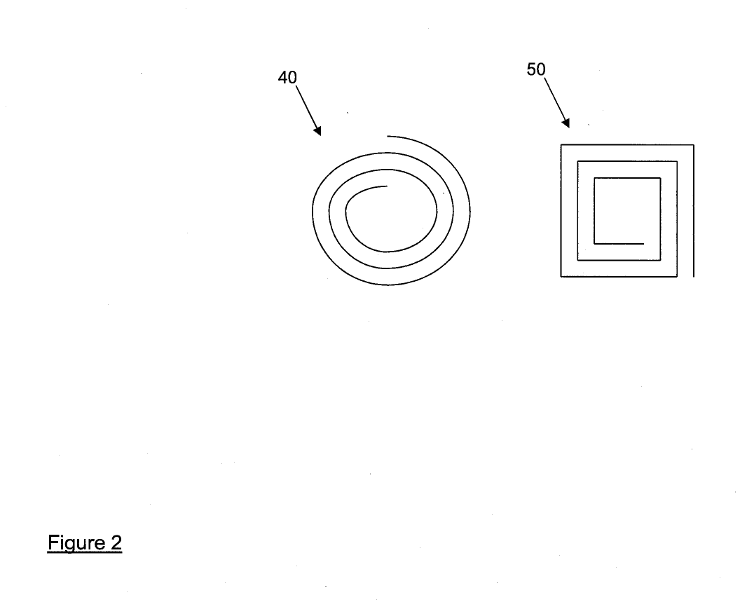

Thus, the universal antenna 32 may be implemented as a spiral, as illustrated at 40 in FIG. 2, provided on two opposed sides of a substrate such as a PCB and having a number (e.g. three or four) of turns on each side of the substrate. The spiral may have a maximum outer diameter in the range 33-43 mm and a minimum inner diameter of around 20 mm. In this case the area of the antenna 32 is in the range 1089 mm² to 1849 mm² (i.e. 33² to 43² mm²) The tracks may have a width of around 1 mm. Alternatively, the universal antenna 32 may be implemented as a generally rectangular coil, as illustrated at 50 in FIG. 2.

In operation of the wireless charging system 10, the wireless charger 20 communicates with the target device 30 to establish that the target device 30 requires charging and the level of power that is required to charge the target device 30. In a wireless charger 20 operating in accordance with the NFC Forum standard, this communication may be via NFC. Alternatively, or where the wireless charger 20 operates in accordance with a different wireless charging standard, this communication may take place over an alternative communication channel such as a Bluetooth® connection between the charger 20 and the target device 30, or a Wi-Fi Direct link.

Once the charging requirements of the target device 30 have been established and the target device 30 has been informed of, or has detected, the carrier frequency used by the wireless charger 20, the target device 30 performs a reconfiguration, if required, to ensure that the universal antenna 32 will be resonant at the carrier frequency used by the charger 20. Thus, if the wireless charger 20 is operating in accordance with the Qi standard, the universal antenna 32 must be resonant between 100 and 200 kHz, typically at 150 kHz, whilst if the wireless charger 20 is operating in accordance with the A4WP standard the universal antenna 32 must be resonant at around 6.78 MHz, and if the charger 20 is operating in accordance with the NFC Forum standard, the universal antenna 32 must be resonant at around 13.56 MHz.

To configure the target device 30 for operation with different carrier frequencies used by different wireless charging standards, the variable capacitance 34 is adjusted to a value that will cause the universal antenna 32 to be resonant at the carrier frequency used by the wireless charger 20.

As the load impedance (which may be represented by the impedance 36 in FIG. 1) of the target device 30 affects the value of antenna coupling between the charging antenna 22 of the wireless charger and the universal antenna 32 of the target device 30, the target device 30 may also adjust the impedance 36 to a value conducive to optimal coupling between the charging antenna 22 and the universal antenna 32.

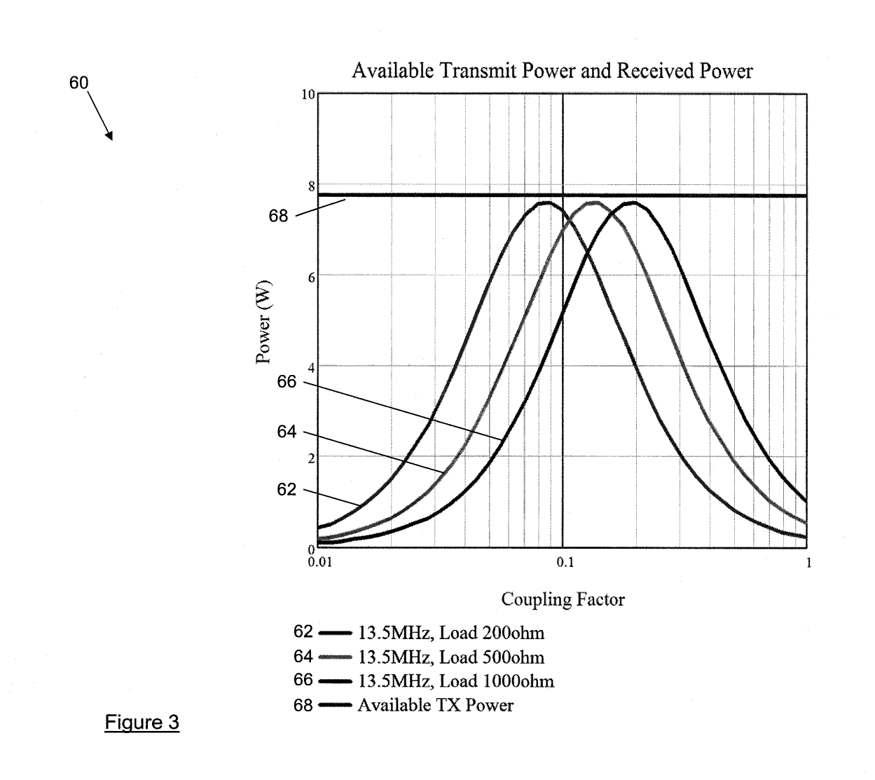

FIG. 3 is a graph 60 illustrating received power transfer at a target device 30 using the universal antenna 32 for different load impedances in the target device 30 when a charging frequency of 13.56 MHz is used.

The first trace 62 of the graph 60 shows the performance of the universal antenna 32 with a carrier frequency of 13.5 MHz and a load impedance of 200 ohms. The second trace 64 shows the performance of the antenna 32 with a carrier frequency of 13.5 MHz and a load impedance of 500 ohms, whilst the third trace 66 shows the performance of the antenna 32 with a carrier frequency of 13.5 MHz and a load impedance of 1000 ohms.

The maximum available transmit power, of around 7.5 watts, is indicated by trace 68. As can be seen from FIG. 3, for different antenna coupling factors and load impedances, the received power at the target device 30 is close to the maximum available transmit power, thus demonstrating the efficiency of power transfer in a target device 30 using the antenna 32 at the highest frequency currently in use by the wireless charging standards discussed above.

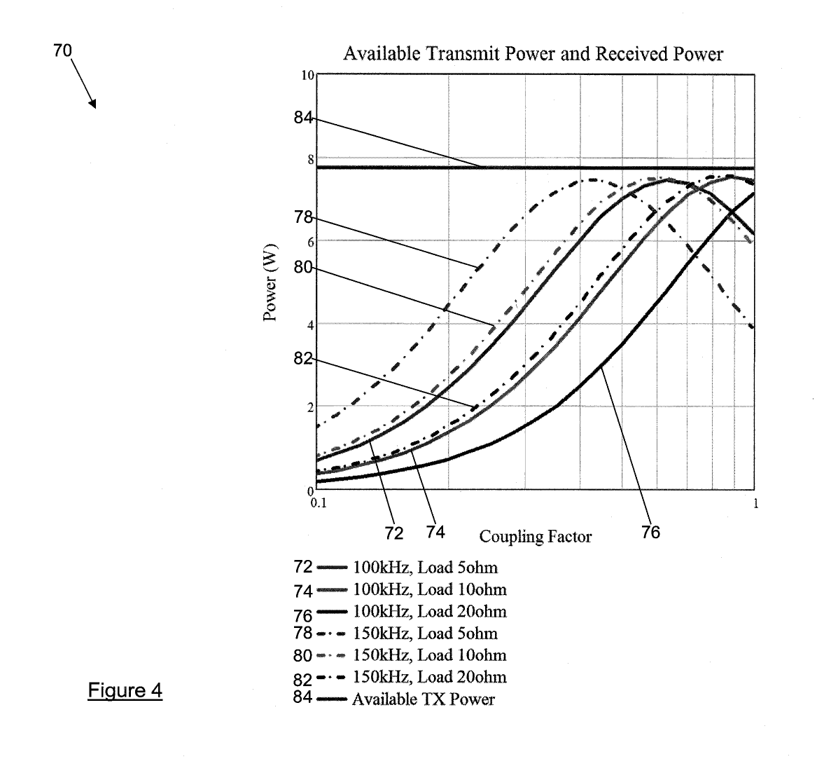

FIG. 4 is a graph 70 illustrating received power transfer at a target device 30 using the universal antenna 32 for different load impedances in the target device 30 when a charging frequency of 100 kHz or 150 kHz is used.

The first trace 72 of the graph 70 shows the performance of the universal antenna 32 with a carrier frequency of 100 kHz and a load impedance of 5 ohms. The second trace 74 shows the performance of the antenna 32 with a carrier frequency of 100 kHz and a load impedance of 10 ohms, whilst the third trace 76 shows the performance of the antenna 32 with a carrier frequency of 100 kHz and a load impedance of 20 ohms.

The fourth trace 78 of the graph 70 shows the performance of the universal antenna 32 with a carrier frequency of 150 kHz and a load impedance of 5 ohms. The fifth trace 80 shows the performance of the antenna 32 with a carrier frequency of 150 kHz and a load impedance of 10 ohms, whilst the sixth trace 82 shows the performance of the antenna 32 with a carrier frequency of 150 kHz and a load impedance of 20 ohms.

The maximum available transmit power, of around 7.5 watts, is indicated by trace 84. As can be seen from FIG. 4, for different antenna coupling factors and load impedances, the received power at the target device 30 is close to the maximum available transmit power, thus demonstrating the efficiency of power transfer in a target device 30 using the antenna 32 at the lowest frequency currently in use by the wireless charging standards discussed above.

Although the universal antenna 32 has been described above and shown in FIG. 1 as being used in a target device 30 (i.e. a device which receives charging power from a wireless charger) it will be apparent that the universal antenna 32 described herein can equally be used as the charging antenna 22 of a wireless charger 20. In this case, the capacitance 24 of the wireless charger 20 would need to be variable, to tune the universal antenna 32 to the particular carrier frequency used or selected by the wireless charger 20.

It will be apparent from the foregoing description that the universal antenna 32 described above offers a flexible way of implementing wireless charging functionality in accordance with different wireless charging standards in both target devices and wireless chargers, without having to use multiple different antennas or a single reconfigurable antenna. The required wireless functionality can be implemented using a single universal antenna 32 of fixed self inductance and area, with simple reconfigurable tuned circuits being used to accommodate different carrier frequencies used by different wireless charging standards.

1. An antenna for wireless charging, the antenna comprising a coil having a fixed inductance and a fixed area, such that the antenna is operable in a frequency range of 100 kHz to 13.56 MHz.

2. An antenna according to claim 1 wherein the fixed inductance is around 8 μH.

3. An antenna according to claim 1 wherein the fixed area is in the range from around 1089 mm² to around 1899 mm².

4. An antenna according to claim 3 wherein the fixed area is around 1450 mm².

5. An antenna according to claim 1 wherein the coil is generally spiral in shape.

6. An antenna according to claim 1 wherein the coil is generally rectangular in shape.

7. A wirelessly rechargeable device comprising an antenna according to claim 1.

8. A wirelessly rechargeable device according to claim 7, further comprising a tuning component for tuning the antenna to a desired resonant frequency.

9. A wirelessly rechargeable device according to claim 8 wherein the tuning component comprises a variable capacitance.

10. A wireless charger comprising an antenna according to claim 1.

11. A wirelessly charger according to claim 10, further comprising a tuning component for tuning the antenna to a desired resonant frequency.

12. A wireless charger according to claim 11 wherein the tuning component comprises a variable capacitance.
